(19) United States
(12) Patent Application Publication
(10) Pub. No.: US 2026/0235803 A1
(43) Pub. Date: Aug. 13, 2026

(54) Tunable Metasurface Optical Fibers for Advanced Light Manipulation

(71) Applicant: The Regents of the University of California, Oakland, CA (US)

(72) Inventors: Ho Wai Lee, Irvine, CA (US); Andrew Palmer, Irvine, CA (US)

(21) Appl. No.: 19/474,705

(22) PCT Filed: Apr. 19, 2024
(86) PCT No.: PCT/US24/25434

§ 371 Date: Oct. 11, 2025

Related U.S. Application Data
(60) Provisional application No. 63/460,771, filed on Apr. 20, 2023.

(51) Int. Cl. G02B 6/028; G02B 1/00; H04B 10/2581; H04B 10/548

(52) U.S. Cl. CPC G02B 6/0288; G02B 1/002; H04B 10/2581; H04B 10/548; G02B 2207/101

(57) ABSTRACT

Tunable metasurface optical fibers for advanced light manipulation are provided. In one embodiments, a tunable metasurface optical fiber device for light manipulation is provided, the tunable metasurface optical fiber device comprising: a multimode optical fiber configured to receive a phase modulated input beam; and an at least one optical metasurface(s), wherein each of the at least one optical metasurface(s) produces a tunable output.

### CROSS-REFERENCE TO RELATED APPLICATION

The current application claims priority to U.S. Provisional Patent Application No. 63/460,771, filed on Apr. 20, 2023, the disclosure of which is incorporated herein by reference.

### FEDERAL FUNDING SUPPORT

This invention was made with Government support under Grant No. FA9550-21-1-02204, awarded by the Air Force Office of Scientific Research. The Government has certain rights in the invention.

### FIELD OF THE INVENTION

The present invention generally relates to optical communications and more specifically to tunable metasurface optical fibers for advanced light manipulation.

### BACKGROUND

Optical communications or optical telecommunications may be described as communication using light to carry information. Typically, an optical communication system may use a transmitter, which may encode a message (e.g., information) into an optical signal, a channel, which may carry the signal to its destination, and a receiver, which may reproduce the message from the received optical signal. Optical communication systems may utilize optical fibers, optical amplifiers, lasers, switches, routers, and other related technologies.

### BRIEF DESCRIPTION OF THE DRAWINGS

The various embodiments of the present tunable metasurface optical fibers for advanced light manipulation (may be referred to as “tunable metasurface optical fibers”) now will be discussed in detail with an emphasis on highlighting the advantageous features. These embodiments depict the novel and non-obvious features of tunable metasurface optical fibers shown in the accompanying drawings, which are for illustrative purposes only. These drawings include the following figures:

FIG. 1 is a diagram illustrating a tunable meta-optical fiber (may also be referred to herein as a “tunable metasurface optical fiber”) based on wavefront shaping in accordance with an embodiment of the invention.

FIG. 2A is a graph illustrating simulation of a tunable metasurface on an optical fiber, demonstrating beam deflection to a 45° angle with 80% efficiency in accordance with an embodiment of the invention.

FIG. 2B is a diagram illustrating a bi-layer metasurface enhancing a beam deflection angle and efficiency in accordance with an embodiment of the invention.

FIG. 3 is a schematic diagram illustrating a setup for a meta-optical fiber device, which enables structured MMF output and tunable “meta”-fiber functionality, in accordance with an embodiment of the invention.

FIG. 4A is a schematic diagram illustrating a tunable metasurface optical fiber of a meta-optical fiber device in accordance with an embodiment of the invention.

FIG. 4B is an optical microscope image of TiO₂ metasurfaces of a tunable metasurface optical fiber of a meta-optical fiber device in accordance with an embodiment of the invention.

FIG. 4C is a schematic diagram illustrating an individual metasurface region in accordance with an embodiment of the invention.

FIGS. 5A-C are diagrams illustrating normalized intensity of transmitted light demonstrating effective steering to various angles in accordance with an embodiment of the invention.

FIG. 6 illustrates a comparison between the output intensity profiles of a multimode optical fiber (MMF) corresponding to an unstructured input and a structured input following a calibration algorithm in accordance with an embodiment of the invention.

FIGS. 7A-D are diagrams illustrating output speck patterns of a standard MMF in the image plane (FIG. 7A) and the Fourier plane (FIG. 7B), as compared with output speck patterns of a meta-optical fiber device in the image plane (FIG. 7C) and the Fourier plane (FIG. 7D) in accordance with an embodiment of the invention.

FIG. 7E is a diagram illustrating the output speck patterns of a meta-optical fiber device in the Fourier plane with various off-axis angles highlighted in accordance with an embodiment of the invention.

FIG. 8 is a flowchart illustrating a process for fabricating tunable meta-optical fibers in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features.

One aspect of the present embodiments includes the realization that conventional single mode optical fibers (SMFs) guide light well, and have a consistent output illumination pattern which is predetermined by their design before fabrication. This has allowed them to see broad use in a variety of fields, including optical communications, medical imagining, and laser surgery. However, the output light of optical fiber is fixed, naturally diverging, and limited by the properties of the fiber core, requiring the use of additional, bulky components to enable advanced optical functionalities. Such limitations may be addressed via the introduction of optical metasurfaces to the fiber endface: metallic or dielectric nanostructures which can control the amplitude and phase of transmitted light with sub-wavelength spatial resolution, allowing them to reproduce the effects of bulk optical components (e.g., lensing and optical deflection effects), and even enable novel functions and applications (e.g., sensing and wave shaping effects). However, their functionality is also typically locked in during fabrication, leading still to a single, static optical output.

Another aspect of the present embodiments includes the realization that multimode optical fibers (MMFs) have much larger core sizes than typical SMFs, and scramble the phase and amplitude of the transmitted optical signal during propagation, leading to a complex and chaotic speckle pattern output. This chaos is something that the present embodiments may exploit: by carefully controlling the fiber input, structuring the beam using a spatial light modulator (SLM), the present embodiments make it is possible to characterize and control the beam scrambling, to produce a specific desired output pattern. This approach may require additional considerations, though; functions beyond beam shaping may be more difficult to achieve, and the angular spread of the output may be limited by the numerical aperture of the fiber.

Another aspect of the present embodiments includes the realization that compared to conventional optical fibers, the present tunable meta-optical fiber devices (e.g., devices utilizing tunable metasurface optical fibers) are capable of creating a much wider variety of outputs: beam steering to more extreme angles, focusing to a wider range of distances, and advanced functionalities such as polarization conversion, filtration, and more. The present embodiments represent a solution which is much more active and tunable than is possible with a metasurface fiber alone, allowing for switchable, spatially movable, and time-varying functionality.

Another aspect of the present embodiments includes the realization that the present embodiments' all-fiber design allows it to be used in a number of specialized applications, including next-generation endoscopic imaging, laser surgery, and all-fiber communication networks, etc. At the same time, it also has the potential for a greater range of active functionality than traditional flat metasurfaces; controlled MMF propagation has been shown to enable reconstructive imaging, controllable nonlinearities, and other features unique to the fiber platform.

Turning now to the drawings, tunable metasurface optical fibers for advanced light manipulation are provided. In many embodiments, the invention represents a fundamentally new optical fiber technology for advanced light manipulation using the integrated optical metasurfaces and interference nature of multimode optical fibers. The large core size of multimode optical fibers allows the present embodiments to pattern multiple distinct metasurfaces on different regions of the fiber endface, each with their own unique optical functionality. By using a spatial light modulator to structure the output light, the beam may be guided to one specific metasurface at a time, activating that function while disabling the rest. The combination of such techniques, therefore, allows for actively tunable and highly multifunctional integrated fiber devices, as further described below. Such control over the output of an optical fiber is unprecedented, and opens doors for a number of advanced functions and applications, such as, but not limited to, high-precision laser surgery, next-generation endoscopic imaging, and all-fiber optical communication networks. Tunable meta-optical fibers based on wavefront shaping in accordance with embodiments of the invention are discussed further below.

### Tunable Meta-Optical Fibers

As described here, the present embodiments represent the first combination of optical metasurfaces and structured multimode fiber output, and is capable of actively control of advanced optical properties such as tunable light focusing, large angle beam steering, and producing active optical functions far beyond the capabilities of other optical fiber components. Although described herein as a plurality of metasurfaces or metasurface regions (e.g., utilizing an array), the present embodiments may be implemented as a single metasurface to achieve tunable functions. For example, the present embodiments may be implemented in a single metasurface without utilizing arrays to achieve tunable functionality. In addition, the present embodiments may be described herein as a particular sized and/or shaped array such as a 3×3 array or a 9 square array. However, the use of a particular sized and/or shaped array is exemplary. For example, the present embodiments may be any size and/or shape such as, but not limited to 16 square array (e.g., 4×4 array), 25 square array (e.g., 5×5 array), 100 square array (10×10 array), etc.

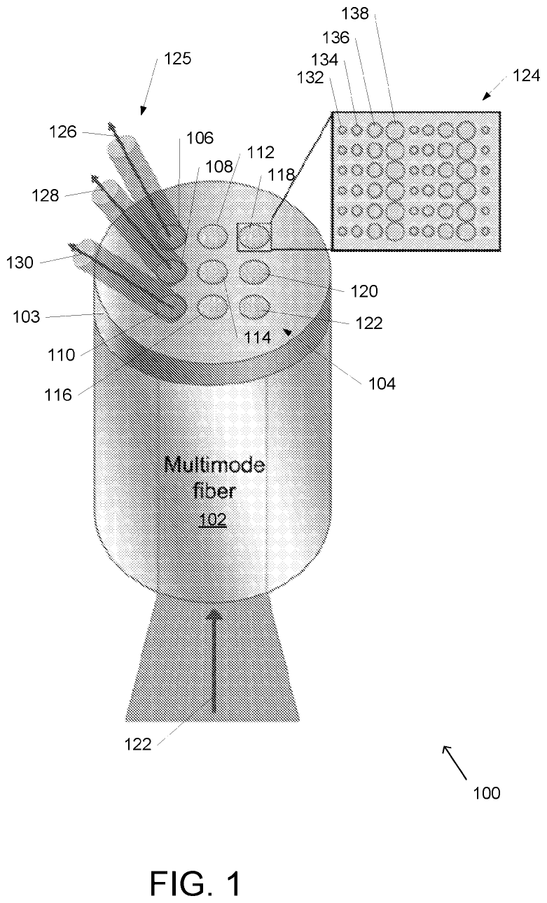

A diagram illustrating a concept of a tunable “meta”-optical fiber based on wavefront shaping in accordance with an embodiment of the invention is shown in FIG. 1. In many embodiments, the meta-optical fiber 100 may include a multimode fiber 102 having an endface 103 that includes one or more metasurface regions 104. For example, the metasurface regions may include a first metasurface region 106, a second metasurface region 108, a third metasurface region 110, a fourth metasurface region 112, a fifth metasurface region 114, a sixth metasurface region 116, a seventh metasurface region 118, an eighth metasurface region 120, and a ninth metasurface region 122, as further described below.

In reference to FIG. 1, through careful calibration and structuring of the input (e.g., phase modulated input beam 122), the transmitted signal (e.g., tunable output 125) can be directed into one of the distinct metasurface regions 104, each of which deflect the optical beam (e.g., the phase modulated input beam 122) to a different extreme far-field angle. For example, as illustrated in FIG. 1, the first metasurface region 106 may deflect the input beam 122 to produce a first defected beam 126. Further, the second metasurface region 108 may deflect the input beam 122 to produce a second defected beam 128. Furthermore, the third metasurface region 110 may deflect the input beam 122 to produce a third defected beam 130. In addition, the fourth, fifth, sixth, seventh, eighth, and ninth meta surface regions 112, 114, 116, 118, 120, 122 may also deflect the input beam 122 to produce defected beams, respectively. The deflected beams can be actively controlled via the modulated input beam 122. Such active function is not limited to beam steering, but can apply to tunable focusing, color filtering, etc.

In addition, FIG. 1 includes a close-up view 124 of one of the metasurface regions (i.e., the seventh metasurface region 118). In some embodiments, the metasurfaces may be composed of a square array of dielectric nanostructures (e.g., TiO₂ nanocylinders), with their varying diameters (e.g., a first, second, third, fourth diameters 132, 134, 136, 138) controlling the phase of the transmitted light. By arranging the unit elements as to impart a linear phase gradient, the input beam 122 can be deflected to a specific angle. Meanwhile, the present embodiments' technique for output structuring is based on a relatively simple algorithm, removing the need for precise knowledge of the fiber geometry, and for the use of computationally expensive techniques such as full-device simulations or neural networks.

The integration of metasurfaces on the optical fiber endface may itself be a burgeoning field; of these “meta”-fiber device prototypes in the literature, the vast majority make use of metallic metasurfaces, due to their ease of fabrication. However, such devices have relatively low efficiencies (~10%), and are therefore unable to be combined effectively with the output structuring technique.

In further reference to FIG. 1, in some embodiments, the metasurfaces may be composed of a square array of TiO₂ nanocylinders, with constant height between 0.5-1 micron depending on the design. By varying the diameter of an individual cylinder (e.g., a first, second, third, fourth diameters 132, 134, 136, 138), the effective path length of light travelling through it is changed, controlling the phase of the transmitted light at that location. By arranging the unit elements as to impart a linear phase gradient, the input beam 122 can be deflected to a specific angle. So, the elements of the present metasurface designs vary in diameter periodically, with periods depending on the angle that may be desired to deflect the beam to.

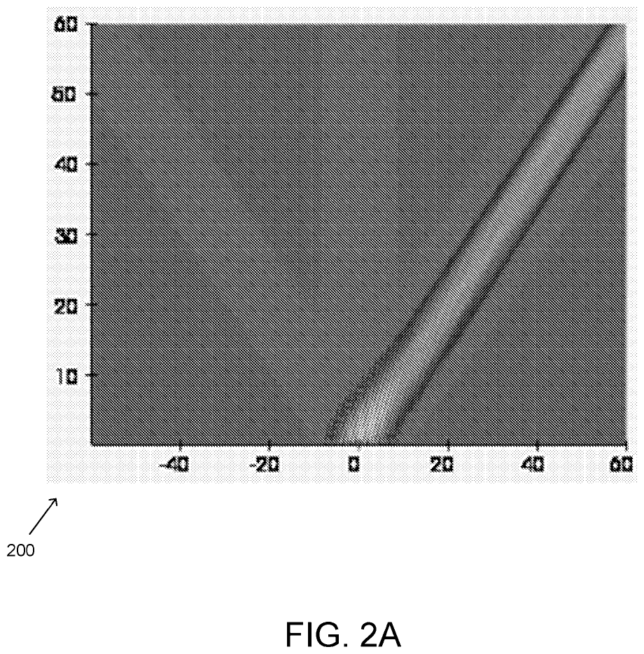

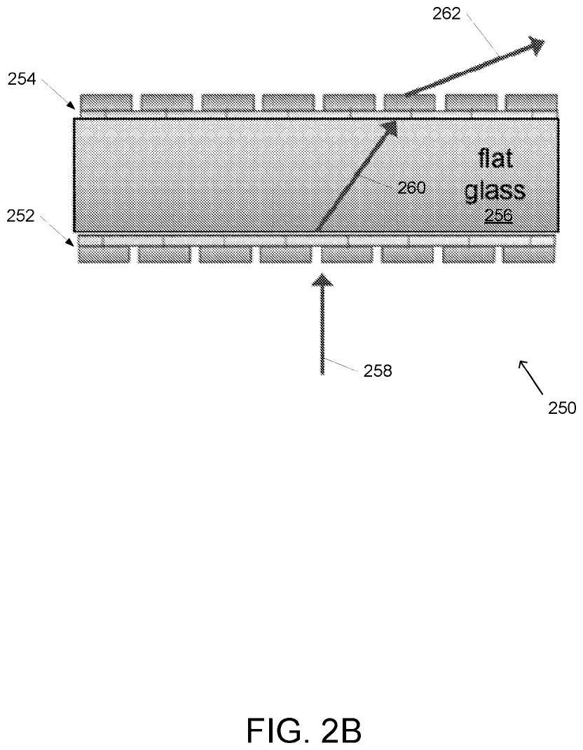

The present embodiments have simulated the result of incident light with wavelength of 633 nm on the metasurfaces using Ansys Lumerical FDTD in order to test their performance. A 5 nm mesh size was utilized around the metasurface region itself, and as coarse mesh as possible in the free-space propagation region; as well, the metasurface was simulated as a single row with periodic boundary conditions, in order to minimize the computational load. By calculating the proportion of the incident light which is deflected to the design angle, within a range of 3 times the full width at half maximum intensity, a metric for the total efficiency of our beam-steering device was obtained. Using this value for optimization, the height and periodicity of the meta-atoms with respect to the wavelength were varied, in order to maximize the efficiency. The chosen height of 0.5-1 micron of the meta-atom gives a strong phase response with our high-index dielectric material, which remained fabricable with electron beam lithography. And, by keeping the distance between cylinders under half of the wavelength, and the periodicity to a simple ratio of the wavelength, the coherence reconstruction of the chosen linear phase gradient was maintained, with minimal extraneous beams. The present embodiments include successfully designed TiO₂ metasurfaces which are capable of beam steering to much larger angles than can be achieved with spatial light modulator-based output structuring alone. For example, beam deflection angles may be any angle including, but not limited to from 30-70°. A graph illustrating simulation of a tunable metasurface on an optical fiber in accordance with an embodiment of the invention is shown in FIG. 2A. The graph 200 demonstrates beam deflection to a 45° angle with 80% efficiency.

In order to further increase the efficiency, particularly for steering angles above 60°, the present embodiments may also utilize a double-layer metasurface structure, with two distinct TiO₂ metasurfaces separated by a thin layer of glass. A diagram illustrating a bi-layer metasurface enhancing a beam deflection angle and efficiency in accordance with an embodiment of the invention is shown in FIG. 2B. The double-layer metasurface structure 250 may include a first metasurface 252 and a second metasurface 254 that may be separated by a layer of flat glass 256. In this way, the burden of beam deflection is split between the two metasurfaces 252, 254, allowing for two more efficient designs to be used in place of one lossy one. For example, the first metasurface 252 may deflect an input beam 258 resulting in an intermediate deflected beam 260 and the second metasurface 254 may deflect the intermediate deflected beam 260 resulting in an output beam 262. For a steering angle of 70°, the present embodiments were able to achieve nearly double the efficiency using this technique as compared to a single-layer metasurface design—to our knowledge, the best reported beam-steering performance to such an extreme angle. Although specific beam deflection angles are provided herein, the present embodiments may be utilized for various different angles and continuous angles. Further, although TiO₂ is utilized as the dielectric material, the present embodiments may utilize a variety of dielectric materials beyond those specifically referenced herein.

Although specific tunable meta-optical fibers, simulations, and bi-layer metasurfaces are discussed above with respect to FIGS. 1A-2B, any of a variety of tunable meta-optical fibers, simulations, and various metasurfaces as appropriate to the requirements of a specific application can be utilized in accordance with embodiments of the invention. Setups for tunable meta-optical fibers are discussed further below.

### Setups for Meta-Optical Fibers

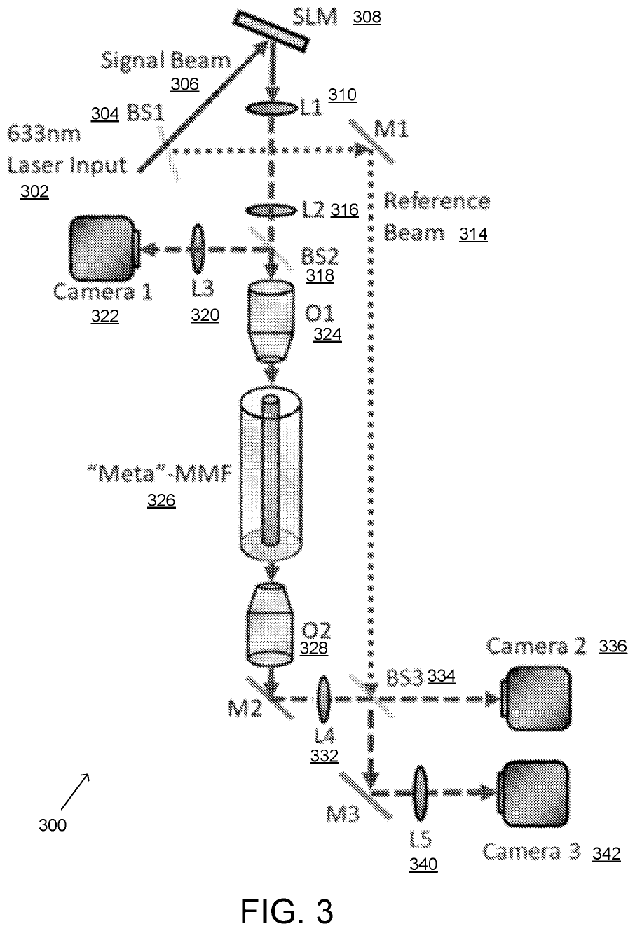

A schematic diagram illustrating a setup for a meta-optical fiber device, which enables structured MMF output and tunable “meta”-fiber functionality, in accordance with an embodiment of the invention is shown in FIG. 3. The setup 300 demonstrates the tunable meta-optical fiber function. The setup 300 may include a beam splitter BS1 304 that may split an input light (may also be referred to as an “input beam”) 302 from an input source such as, but not limited to, a He—Ne laser. In many embodiments, the beam splitter BS1 304 may split the input light into two paths. The first path may be a signal path utilizing a signal beam 306, which may be incident upon and modulated by a spatial light modulator (SLM) 308 before serving as a device input to meta-optical fiber devices. In many embodiments, the SLM 308 may be used to carefully structure the input beam 302 via phase modulation. The second path may be a reference path, which may be used to obtain phase information from the device output of meta-optical fiber devices at the far end of the setup 300. In various embodiments, focusing the signal beam 306 onto a specific point on the fiber core, the resulting output at the desired location can be monitored. Scanning the phase of this input may affect the output intensity at this location; optimizing for the highest intensity and linearly combining many independently optimized inputs allows for the output to be concentrated within a specific region of the distal endface of meta-optical fiber devices. This spot can be located anywhere within the fiber core region, with the beam intensity diminishing somewhat as the distance from the center increases, and allows the signal to be effectively coupled into an optical metasurface at that location.

In reference to FIG. 3, the setup 300 may also include lenses L1 310 and L2 316 that may form a 4f optical relay, resizing and imaging the SLM active area onto the back focal plane of microscope objective O1 324 so that the corresponding Fourier plane can be projected onto the optical fiber input endface of meta-optical fiber devices. The setup 300 may also include beam splitter BS2 318 that allows the input through to O1 324 and the Meta-MMF 326, while deflecting the back-reflected light to allow the fiber input endface to be imaged on Camera 1 322 by lens L3 320. The Meta-fiber output is then imaged on Camera 2 336 by microscope objective O2 328 and lens L4 332 after interference with the reference beam 314 utilizing a beam splitter BS3 334. Lastly, the Fourier transform of this output image is taken by lens L5 340, and the resulting Fourier plane is imaged on Camera 3 342.

To demonstrate the potential for improved functionality this kind of device offers, the present embodiments may include designs for meta-optical fiber devices (may also be referred to herein as “metasurface optical fiber devices”) comprised of few distinct beam-steering metasurface regions such as, but not limited to, a 3×3 array. Then, directing the fiber output to one chosen metasurface region at a time will allow for steering of the beam to 9 separate, much more extreme angles: up to 4-6× greater than are possible using output structuring alone. Further, the efficiencies of the present metasurfaces, even at the furthest steering angles, are much higher than beams steered using this previous method. In addition, this device is not dependent on the length or configuration of the optical fiber, allowing for its use in distant, enclosed, and otherwise hard-to-access spaces. This may be the first meta-optical fiber device to utilize this novel tuning mechanism, and an early display of the control and functionality enabled by our methods.

Although setups for devices utilizing tunable meta-optical fibers are discussed above with respect to FIG. 3, any of a variety of setups as appropriate to the requirements of a specific application can be utilized in accordance with embodiments of the invention. Fabrication and optimization considerations in accordance with embodiments of the invention are discussed further below.

### Fabrication and Optimization Considerations

We have successfully designed TiO₂ metasurfaces which are capable of beam steering to much larger angles than can be achieved with SLM-based output structuring alone-anywhere from 30-70°. The present embodiments may also be utilized to fabricate these devices on fiber endfaces, and combined with various output structuring setups to form a full working prototype, as further described above.

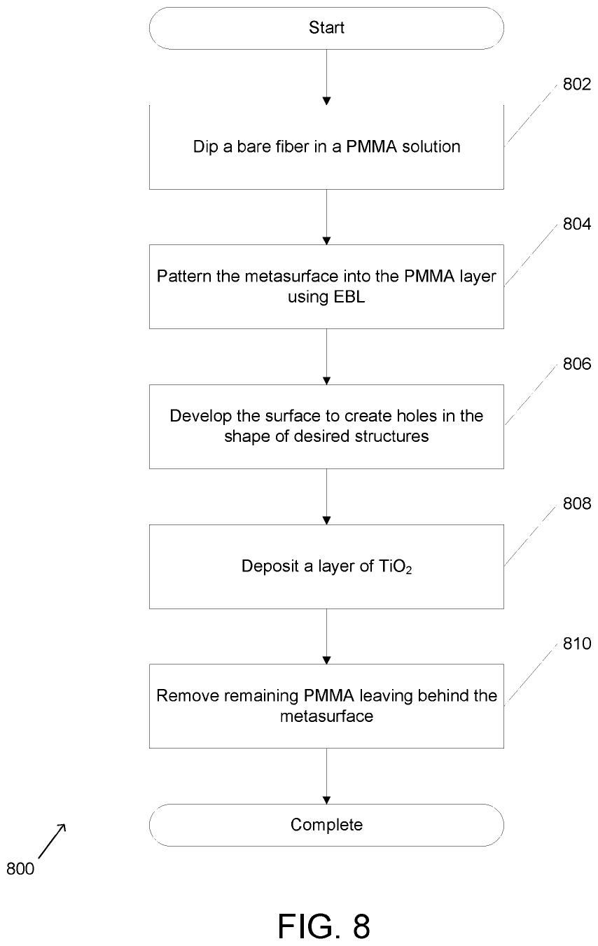

The present embodiments may be fabricated utilizing a variety of fabrication methods including but not limited to, fabricating dielectric nanostructures, directly on the fiber tip. For example, one such fabrication method is provided below. A flowchart illustrating a process for fabricating tunable meta-optical fibers in accordance with an embodiment of the invention is shown in FIG. 8. The process 800 may include dipping (802) a bare fiber in a PMMA solution to coat the endface in a thin layer to be used as an electron beam lithography (EBL) resist. The process 800 may also include patterning (804) the metasurface into the PMMA layer using EBL, and developing (806) the surface to create holes in the shape of desired structures. In addition, the process 800 may also include depositing (808) a layer of TiO₂ (chosen due to its high refractive index and low loss in the visible range) via various methods including, but not limited to, sputtering, and removing (810) the remaining PMMA (e.g., using a solvent), leaving behind the final metasurface.

The present embodiment may also include fabricating highly efficient TiO₂ metasurfaces on optical fiber endface, and combining with output structuring setup for full working, tunable meta-optical fiber devices, testing device performance and collecting data collection.

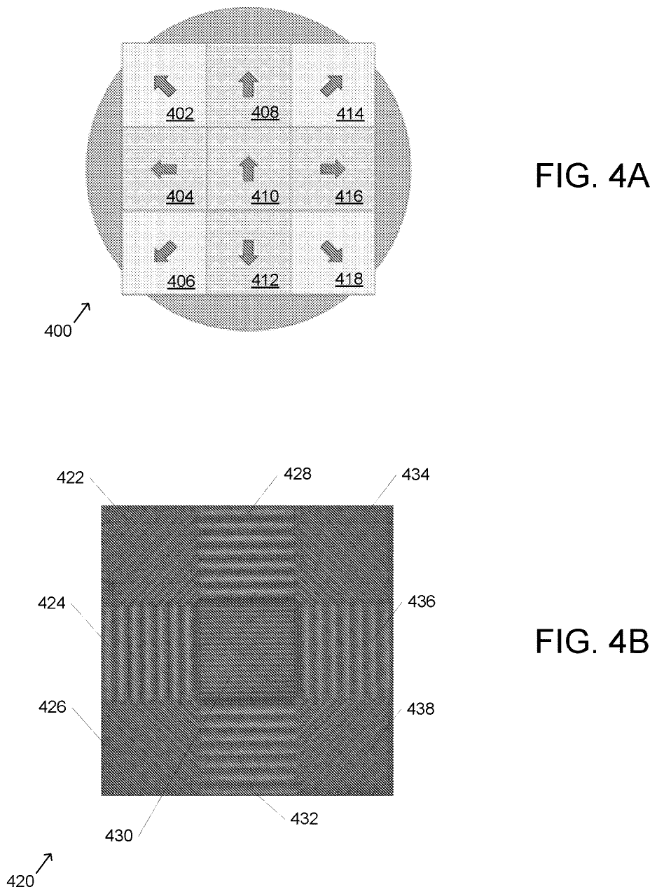

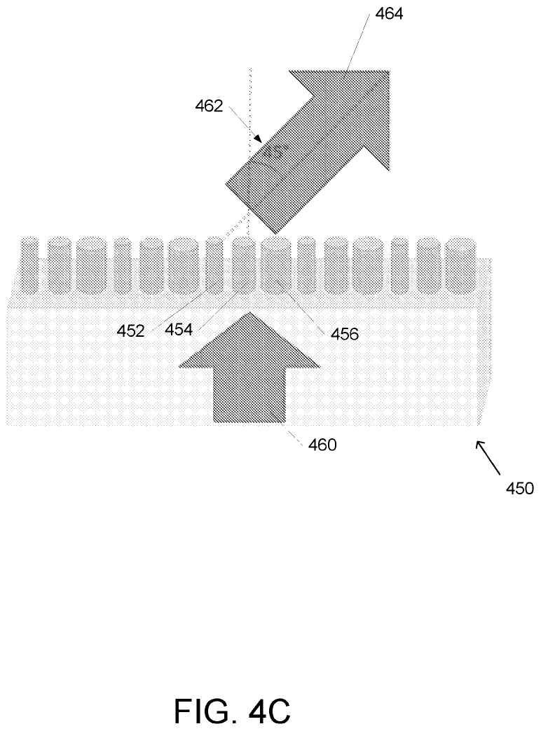

Tunable meta-optical fiber devices may be optimized with various considerations. For example, a schematic diagram illustrating a device having a tunable metasurface optical fiber in accordance with an embodiment of the invention is FIG. 4A. In many embodiments, the device 400 may include 9 distinct metasurface regions. For example, the device 400 may include a first metasurface region 402, a second metasurface region 404, a third metasurface region 406, a fourth metasurface region 408, a fifth metasurface region 410, a sixth metasurface region 412, a seventh metasurface region 414, an eighth metasurface region 416, and a ninth metasurface region 418. In some embodiments, the metasurface regions may be various shapes such as, but not limited to square shapes. In some embodiments, the metasurface regions may be various sizes, such as, but not limited to, square shapes each having a width of 13 μm in order to overlap the fiber core as best as possible.

In reference to FIG. 4A, the various metasurface regions may be configured to deflect incident light at particular angles. In some embodiments, one or more metasurface regions may be configured in deflect incident light at the same angles. For example, a first group of metasurface regions that may include the second, the fourth, sixth, and eighth metasurface regions 404, 408, 412, 416, where the first group of metasurface regions may be configured to deflect incident light to an angle of 20°. Further, a second group of metasurface regions may include the first, third, seventh, and ninth metasurface regions 402, 406, 414, 418, where the second group may be configured to deflect incident light to an angle of 45°. Moreover, a third group of metasurface regions may include the fifth metasurface region 410, where the third group may be configured to deflect incident light to an angle of 60° In many embodiments, such deflections may be performed with high efficiencies (e.g., the 20°, 45°, and 60° deflections may have efficiencies of 83%, 79%, and 75%, respectively).

In further reference to FIG. 4A, the arrows show the direction of the beam-steering angle, with each metasurface region therefore corresponding to a unique point in the far-field to guide the beam to. These metasurfaces may all be periodic, with the second and third group regions each being composed of 3 unique unit elements (e.g., cylinder radii) and the first group regions having 6 unique elements.

The tunable metasurface optical fibers may be fabricated on various substrates including, but not limited to flat glass substrates. For example, the beam-steering metasurface designs illustrated in FIG. 4A have been fabricated on a flat glass substrate. An optical microscope image of TiO₂ metasurfaces of a tunable metasurface optical fiber of a meta-optical fiber device in accordance with an embodiment of the invention is shown in FIG. 4B. The device 420 may include a first group of metasurface regions that may include the second, the fourth, sixth, and eighth metasurface regions 424, 428, 432, 436, where the first group of metasurface regions may be configured to deflect incident light to an angle of 20° (see Table 1 below for experiment performance results). Further, a second group of metasurface regions may include the first, third, seventh, and ninth metasurface regions 422, 426, 434, 438, where the second group may be configured to deflect incident light to an angle of 45° (see Table 1 below for experiment performance results). Furthermore, a third group of metasurface regions may include the fifth metasurface region 430 and the third group may be configured to deflect incident light to an angle of 60° (see Table 1 below for experiment performance results).

TABLE 1
Simulated vs experimental performance of
the TiO₂ beam deflection metasurfaces

| | Angle | Angle | Efficiency | Efficiency |
|---|---|---|---|---|
| | (Simulated) | (Experiment) | (Simulated) | (Experiment) |
| Metasurface | 20° | 21° | 83% | 80% |
| Group 1 | | | | |
| Metasurface | 45° | 44° | 79% | 57% |
| Group 2 | | | | |
| Metasurface | 60° | 60° | 75% | 29% |
| Group 3 | | | | |

In reference to FIGS. 4A-B, Table 1 provides results of experimental performance in comparison with simulations. By directing visible light to one metasurface region at a time through the use of a single-mode fiber, we were able to measure the efficiency and angle of deflection of the transmitted beam, finding high agreement to within 1° of the design angle in each case. The 3×3 metasurface illustrated in FIG. 4B, may be fabricated utilizing various fabrication methods. For example, the metasurface(s) may be bonded to a multimode fiber endface using optical-grade UV curing adhesive, for verification of the tuning mechanism for a meta-optical fiber device. In another example, the metasurface(s) may be fabricated directly on an optical fiber using nanofabrication techniques.

A schematic diagram illustrating an individual metasurface region in accordance with an embodiment of the invention is shown in FIG. 4C. The metasurface region 450 may include cylinders (e.g., TiO₂ nanocylinders) of varying diameter. For example, the metasurface region 450 may include a first nanocylinder 452 having a first diameter, a second nanocylinder 454 having a second diameter, and a third nanocylinder 456 having a third diameter, where the first, second, and third diameters are not equal. In some embodiments, the third diameter may be larger than the second diameter, and the second diameter may be larger than the first diameter. In some embodiments, the metasurface region 450 may include a repeating pattern of nanocylinders having a first, second, and third diameters. In many embodiments, the metasurface region 450 may deflect an input beam 460 resulting in an output beam 464 that has a specific off-axis angle 462 (e.g.) 45°.

The present embodiments may further optimize these metasurfaces for both performance and fabrication. For example, in some embodiments, performance has been confirmed at an operating wavelength of 633 nm (visible red light), maintaining the above efficiency values despite the finer structure needed. To aid in fabrication, particularly on the optical fiber platform, the metasurface thickness (pillar height) may be limited to 600 nm, and the aspect ratio (height/width) may be limited to <6, leading to more consistent and high-quality nanostructures in the finished product. In a further example and in reference to FIGS. 4A-B, each of the first group of metasurface regions may have a 300 nm period and cylinder radii of 64, 83.5, 98, 111, 127, and 144.5 nm. Moreover, the second group of metasurface regions may have a 300 nm period and cylinder radii of 50, 91.5, and 120.5 nm. In addition, the third group of metasurface regions may have a 244 nm period and cylinder radii of 66, 93 and 116.5 nm.

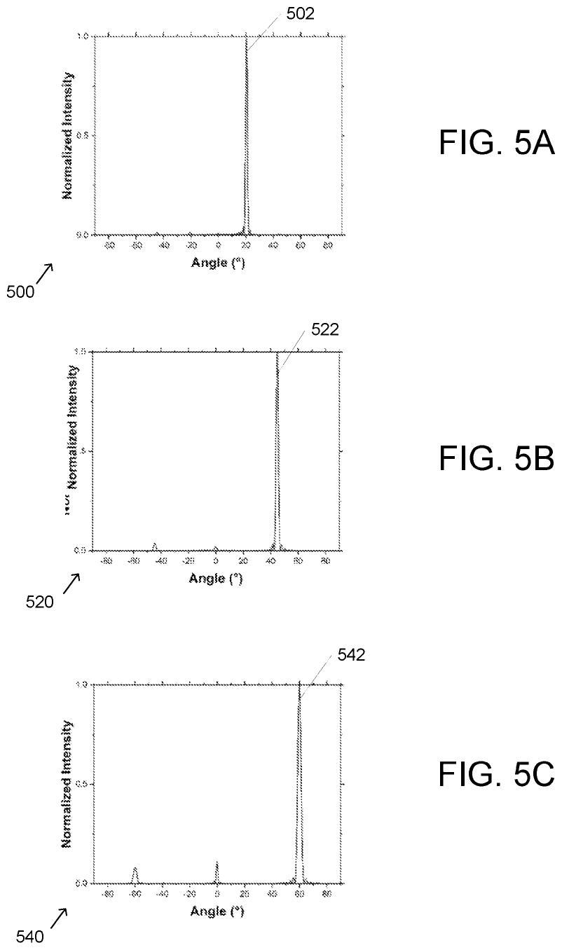

Although fabrication and optimization considerations are discussed above with respect to FIGS. 4A-5C, any of a variety of fabrication and optimization considerations as appropriate to the requirements of a specific application may be utilized in accordance with embodiments of the invention. Additional results and considerations in accordance with embodiments of the invention are further discussed below.

### Additional Results and Considerations

Diagrams illustrating normalized intensity of transmitted light demonstrating effective steering to various angles in accordance with an embodiment of the invention are shown in FIGS. 5A-C. In FIG. 5A, diagram 500 illustrates normalized intensity of the transmitted light in the far field vs. angle after interacting with the first group of metasurface regions with a steering angle of 20°. The spike 502 in diagram 500 demonstrates the effective steering to the 20° angle. In FIG. 5B, diagram 520 illustrates normalized intensity of the transmitted light in the far field vs. angle after interacting with the second group of metasurface regions with a steering angle of 45°. The spike 522 in diagram 520 demonstrates the effective steering to the 45° angle. In FIG. 5C, diagram 540 illustrates normalized intensity of the transmitted light in the far field vs. angle after interacting with the third group of metasurface regions with a steering angle of 60°. The spike 542 in diagram 540 demonstrates the effective steering to the 60° angle.

The present embodiments have successfully structured the output of an unpatterned MMF, in the form of focused spots at desired locations and collimated beams at a desired off-axis angle, both limited to fall within 12° of the optical axis. The structured input to the fiber (following interaction with the SLM) may take the form of a grid (e.g., of 25×25 focused spots), the phase of each of which can be modulated independently. In many embodiments, the output light may be concentrated at a target location past the distal endface by selecting these phase values such that each input spot's corresponding output pattern constructively interferes at the desired point.

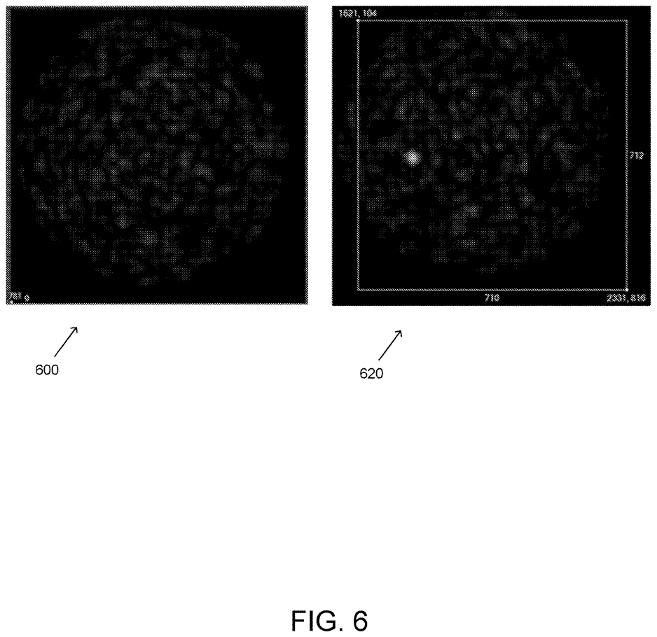

FIG. 6 illustrates a comparison between the output intensity profiles of a MMF corresponding to an unstructured input vs. a structured input following a calibration algorithm in accordance with an embodiment of the invention. The output intensity profile of the MMF corresponding to an unstructured input is provided in diagram 600 and the output intensity profile of the MMF corresponding to a structured input following a calibration algorithm is provided in diagram 620. By imaging the fiber output directly at the distal endface, bright focused spots can be created there which do not persist at any distance away from the fiber tip; by instead imaging at a plane several 10s-100s of microns away, far from the coupled-mode regime, the created bright spot, as seen in diagram 620, takes the form of a collimated pseudo-Gaussian beam. From here, we utilized the same algorithmic process to control the light emerging from the present Meta-MMF, demonstrating experimentally the first tunable metasurface fiber output. The beam-deflection metasurfaces extend the fiber's speckle pattern out to angles of up to 70° in the design directions, allowing us to selectively utilize a single metasurface region at a time and to generate focal spots far beyond the 12° limit of the fiber's numerical aperture (NA).

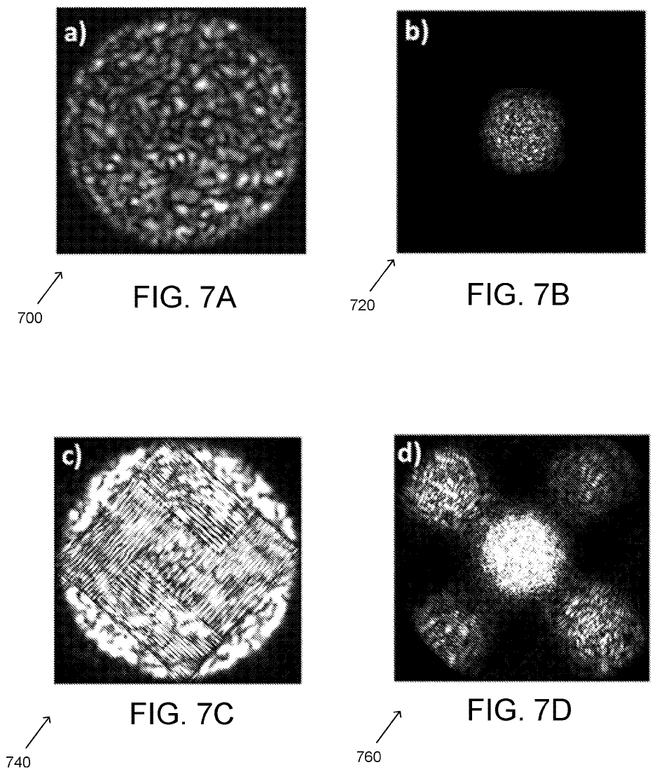

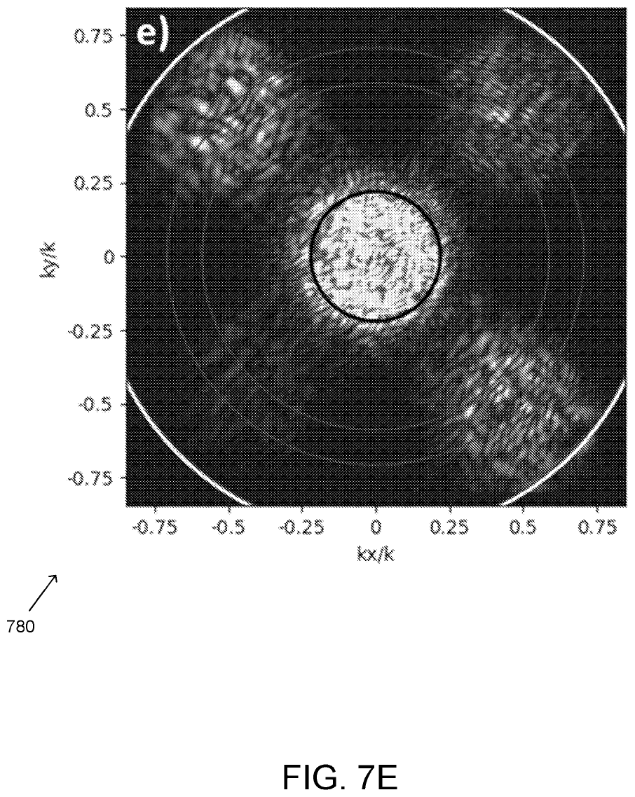

The extreme deflection angles of these off-axis spots are measured using the technique of Fourier plane imaging. FIGS. 7A-D are diagrams illustrating output speck patterns of a standard MMF in the image plane (diagram 700 in FIG. 7A) and the Fourier plane (diagram 720 in FIG. 7B), as compared with output speck patterns of a meta-optical fiber device in the image plane (diagram 740 in FIG. 7C) and the Fourier plane (diagram 760 in FIG. 7D) in accordance with an embodiment of the invention. When an additional lens is placed 1 focal length from the desired image plane (as for L5, FIGS. 7A-E), the optical intensity pattern If on the opposite side takes the form of the Fourier transform of the image plane. Here, the sine of the off-axis angle of propagation at the image plane is directly proportional to the off-axis position at the Fourier plane, allowing output deflection angles of up to 72° in any direction to be measured at once.

FIG. 7E is a diagram illustrating the output speck patterns of a meta-optical fiber device in the Fourier plane with various off-axis angles highlighted in accordance with an embodiment of the invention. Diagram 780 illustrates MMF NA of 12° (center ring), metasurface design steering angles of 37, 45, and 70°, and the microscope objective (O2) NA of 72°.

Although additional results and considerations are discussed above with respect to FIGS. 6-7E, any of a variety of results and considerations as appropriate to the requirements of a specific application may be utilized in accordance with embodiments of the invention. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A tunable metasurface optical fiber device for light manipulation, the tunable metasurface optical fiber device comprising:
a multimode optical fiber configured to receive a phase modulated input beam; and
an at least one optical metasurface(s), wherein the at least one optical metasurface(s) produces a tunable output.

2. The tunable metasurface optical fiber device of claim 1, wherein the core comprises a fiber endface having a at least one distinct region(s).

3. The tunable metasurface optical fiber device of claim 2, wherein each of the at least one optical metasurface(s) is located on each of the at least one distinct region(s) of the fiber endface.

4. The tunable metasurface optical fiber device of claim 3, wherein each of the at least one optical metasurface(s) has a different optical functionality.

5. The tunable metasurface optical fiber device of claim 1 further comprising a spatial light modulator configured to select one of the at least one optical metasurface(s) while disabling the others.

6. The tunable metasurface optical fiber device of claim 1, wherein each of the at least one optical metasurface(s) deflects an optical beam for beam steering.

7. The tunable metasurface optical fiber device of claim 6, wherein the beam steering allows for extreme far-field angles between 30-70 degrees.

8. The tunable metasurface optical fiber device of claim 6, where the output beams are actively controlled via the phase modulated input beam.

9. The tunable metasurface optical fiber device of claim 1, wherein the at least one optical metasurface(s) is configured for tunable focusing.

10. The tunable metasurface optical fiber device of claim 1, wherein the at least one optical metasurface(s) is configured for color filtering and beam deflecting.

11. The tunable metasurface optical fiber device of claim 1, wherein each of the at least one optical metasurface(s) comprises a square array of dielectric or metallic nanostructures.

12. The tunable metasurface optical fiber device of claim 11, wherein dielectric nanostructures comprise TiO₂ nanocylinders.

13. The tunable metasurface optical fiber device of claim 11, wherein the TiO₂ nanocylinders have a constant height between 0.5-2 microns.

14. The tunable metasurface optical fiber device of claim 11, wherein the dielectric nanostructures include varying diameters for controlling a phase of a transmitted light.

15. The tunable metasurface optical fiber device of claim 11, wherein the dielectric nanostructures are arranged to impart a linear phase gradient allowing the tunable output to deflect to a specific angle.

16. The tunable metasurface optical fiber device of claim 1, wherein the at least one optical metasurface(s) utilizes a double-layer metasurface structure.

17. The tunable metasurface optical fiber device of claim 16, wherein the double-layer metasurface structure comprises two TiO₂ metasurfaces separated by a thin glass layer.

18. The tunable metasurface optical fiber device of claim 1, wherein the at least one optical metasurface(s) includes 9 square metasurface regions.

19. The tunable metasurface optical fiber device of claim 18, wherein the 9 square metasurface regions each have a width of 13 μm.

20. The tunable metasurface optical fiber device of claim 18, wherein the 9 square metasurface regions includes 4 regions that deflect incident light to an angle of 20 degrees, 4 regions that deflect incident light to an angle of 45 degrees, and 1 region that deflects incident light to an angle of 60 degrees.

21. The tunable metasurface optical fiber device of claim 18, wherein each of the 9 square metasurface regions beam steers to a unique point in the far-field.
